(19) United States
(12) Patent Application Publication
(10) Pub. No.: US 2005/0066274 A1
(43) Pub. Date: Mar. 24, 2005

(54) Image processing apparatus, information processing apparatus, and computer product

(76) Inventors: Takezo Fujishige, Kanagawa (JP); Kiyoshi Kasatani, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/912,080

(22) Filed: Aug. 6, 2004

(30) Foreign Application Priority Data
Aug. 8, 2003 (JP) 2003-290255

(51) Int. Cl. G06F 17/00

(52) U.S. Cl. 715/517

(57) ABSTRACT

An image processing apparatus creates a layout image by fetching a layout with various data according to layout information that is held by a desired form which is selected from either one type or a plurality of types of forms which are registered. The image processing apparatus includes a new-form creating unit that creates new layout information and creates a new form from the new layout information; and a new-form registering unit that registers the new form.

### CROSS-REFERENCE TO RELATED APPLICATIONS

The present document incorporates by reference the entire contents of Japanese priority document, 2003-290255 filed in Japan on Aug. 8, 2003.

### BACKGROUND OF THE INVENTION

1) Field of the Invention

The present invention relates to an image processing apparatus and an information processing apparatus that is connected to the image processing apparatus via a communication network. The image processing apparatus is, for example, a digital color copy machine called as Multi Function Peripheral (MFP). The information processing apparatus is, for example, a personal computer.

2) Description of the Related Art

Nowadays, digital copy machines called MFPs are becoming popular. These MPFs include a facsimile (FAX), a printer, and a scanner. A conventional MPF has been disclosed in Japanese Patent Application Laid-Open Publication No. 2001-312389.

The digital copy machines can read handwritten documents or contents printed on papers and convert them into image data (electronic data). The image data is convenient because it can be shared and utilized by multiple users via a network. Therefore, many times the digital copy machines are connected to a network which allows sharing of the image data.

Moreover, in recent years, digital copy machines that can fetch images directly from various recording media that are used in digital cameras have been developed. These digital copy machines are convenient because they do not require any special cables or device drivers. Moreover, in these digital copy machines, as shown in FIG. 15, images a fetched from a digital camera can even be arranged as desired with memo spaces b, and the resultant image c can be printed.

Conventionally, predetermined layouts of the images and memo spaces are prepared at the time of shipment of the digital copy machines, so that the user has only limited options.

### SUMMARY OF THE INVENTION

It is an object of the present invention to solve at least the problems in the conventional technology.

An image processing apparatus according to an aspect of the present invention creates a layout image by fetching a layout with various data according to layout information that is held by a desired form which is selected from either one type or a plurality of types of forms which are registered. The image processing apparatus includes a new-form creating unit that creates new layout information and creates a new form from the new layout information; and a new-form registering unit that registers the new form.

A computer program according to another aspect of the present invention contains instructions which when executed on a computer cause the computer to create a layout image by fetching a layout with various data according to layout information that is held by a desired form which is selected from either one type or a plurality of types of forms which are registered. The computer program causes the computer to execute creating new layout information and creating a new form from the new layout information; and registering the new form.

An information processing apparatus according to still another aspect of the present invention is connected via a network to an image processing apparatus that creates a layout image by fetching a layout with various data according to layout information that is held by a desired form which is selected from either one type or a plurality of types of forms which are registered. The information processing apparatus includes a new-form creating unit that creates new layout information and creates a new form from the new layout information; and a new-form registering unit that registers the new form.

A computer program according to still another aspect of the present invention contains instructions which when executed on a computer cause an image processing apparatus to create a layout image by fetching a layout with various data according to layout information that is held by a desired form which is selected from either one type or a plurality of types of forms which are registered. The computer program causes the computer to execute creating new layout information and creating a new form from the new layout information that can be used in the image processing apparatus; and sending the new form to the image processing apparatus.

A computer-readable storage medium according to still another aspect of the present invention stores thereon the above computer programs.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a configuration of a system that includes a digital color copy machine according a first embodiment of the present invention;

FIG. 2 is a perspective view of the digital color copy machine;

FIG. 3 is a functional block diagram of the digital color copy machine;

FIG. 4 is a top view of an operation panel;

FIG. 5 is an example of a form that includes predetermined layout information;

FIG. 6 is an example of an image in which images and characters are combined according to the form;

FIG. 7 is a schematic for explaining a process procedure for creating a new form according to the first embodiment;

FIG. 8 is a detailed flow chart of the process procedure for creating a new form;

FIG. 9 is a screen for selecting a form;

FIG. 10 is a display screen of form details;

FIG. 11 is a screen for form search;

FIG. 12 is a screen for selecting a category;

FIG. 13 is a schematic for explaining a process procedure for creating a new form according to a second embodiment;

FIG. 14 is an illustration of a screen for form management; and

FIG. 15 is a schematic for explaining a conventional tecnology.

### DETAILED DESCRIPTION

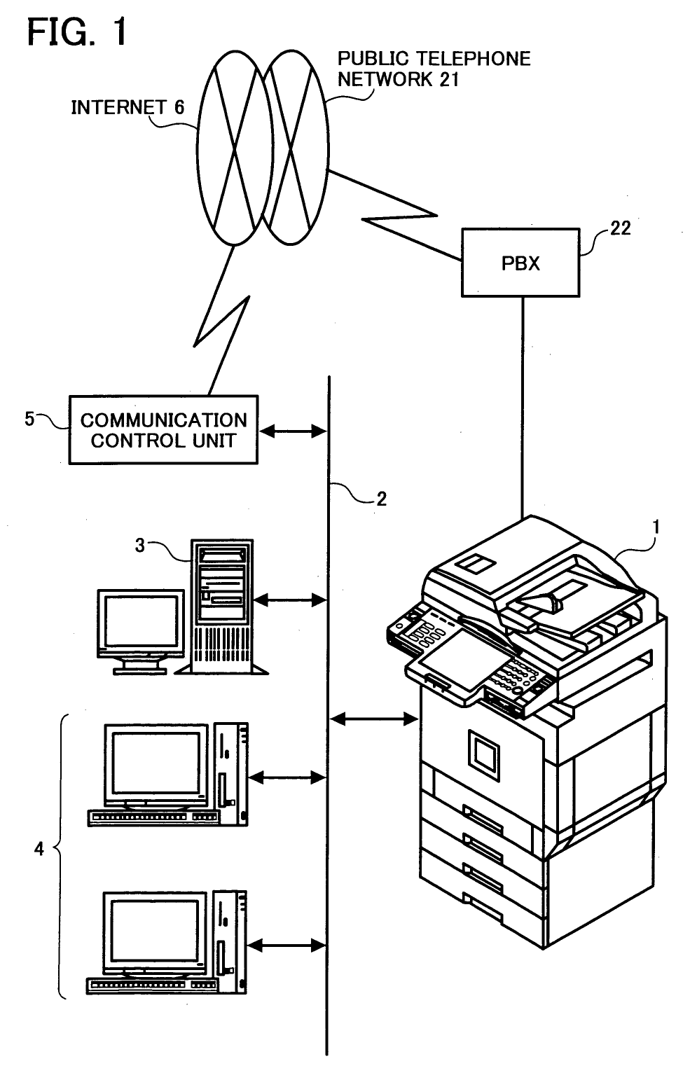

An image processing apparatus according to a first embodiment will be explained with reference to FIGS. 1 to 12. The image processing apparatus according to the embodiment is applied to a digital color copy machine called MFP. The MFP has a copier, a FAX, a printer, a scanner, and can also transmit image data. The image data may be the one that is read by the scanner or that is input into the printer or the FAX from outside.

FIG. 1 is a configuration of a system that includes a digital color copy machine 1 according to the embodiment. The system includes a server computer 3 and client computers 4 that are connected to the digital color copy machine 1 via a local area network (LAN) 2. The server computer 3 and the client computers 4 are information processing devices that execute various kinds of information processing. The server computer 3 supports protocols such as a file transfer protocol (FTP) and a hyper text transfer protocol (HTTP). The server computer 3 can function as a Web server, a mail server, and a domain name server (DNS). In other words, the system provides an environment in which image processing functions, such as image input, image output, and image storage, in the digital color copy machine 1, can be shared over the LAN 2.

The system is connected to the Internet 6 via a communication control unit 5, thereby enabling data communication with an external environment. The communication control unit 5 is a router, a modem, or a digital subscriber line (DSL) modem. However, any other structure that supports transmission control protocol/internet protocol (TCP/IP) communication may also be used. The LAN 2 may be wired or wireless. Wireless communication can be achieved, for example, by infrared rays and radio waves. Wired communication can be achieved, for example, using optical fibers.

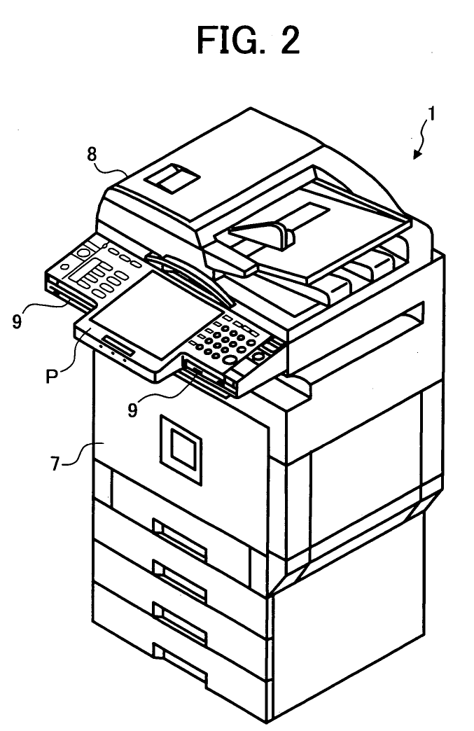

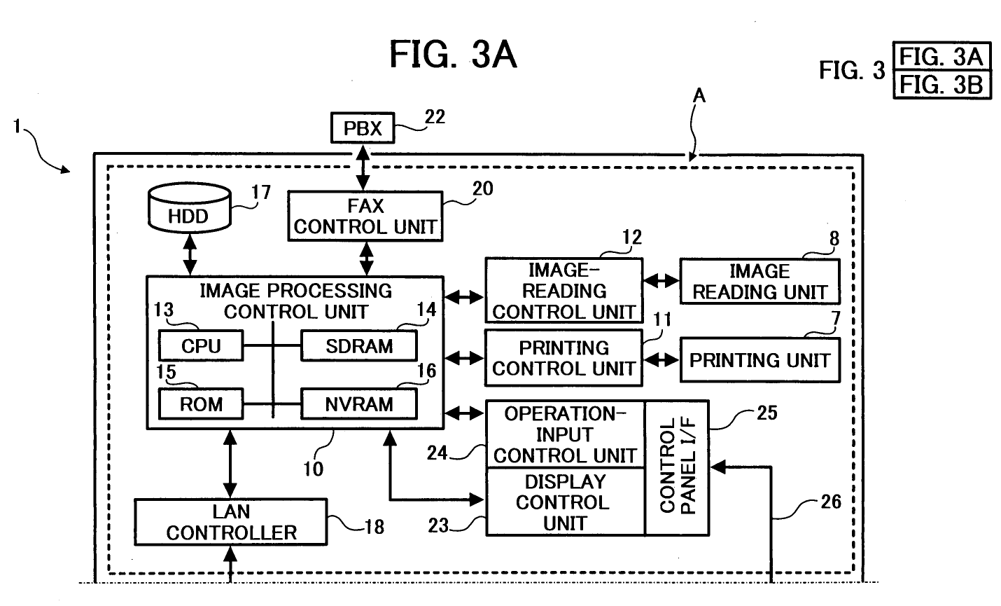

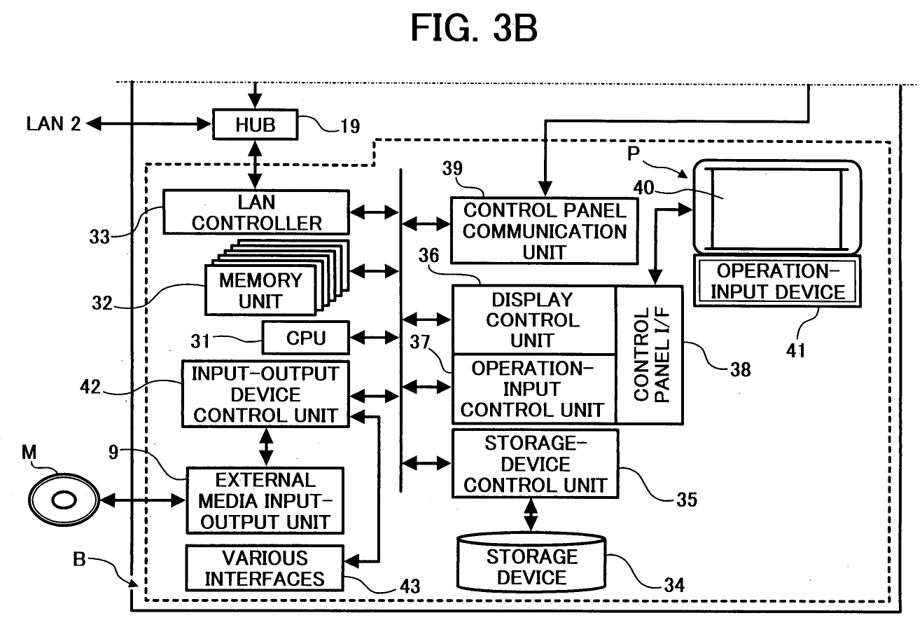

The digital color copy machine 1 will now be described in detail. FIG. 2 is a perspective view of the digital color copy machine 1 and FIG. 3 is a functional block diagram of the digital color copy machine 1. As shown in FIG. 2, the digital color copy machine 1 includes a printing unit 7, an image reading unit 8, an operation panel P, and an external media input-output unit 9. The printing unit 7 is an image forming unit that forms an image on a medium such as a transfer paper. The image reading unit 8 is disposed above the printing unit 7, and reads an image of a document. The external media input-output unit 9 is disposed below the operation panel P. The external media input-output unit 9 can read image files and program codes form a storage medium M (refer to FIG. 3), and can write image files and program codes on the storage medium M. The external media input-output unit 9 has an opening through which a storage medium M can be inserted. This opening is located at such a position that a storage medium M can be inserted in it easily.

The digital color copy machine 1 includes an image processing unit A and an information processing unit B as shown in FIG. 3. The printing unit 7 and the image reading unit 8 are included in the image processing unit A. The operation panel P and the external media input-output unit 9 are included in the information processing unit B.

The image processing unit A further includes an image-processing control unit 10 that controls image processing in the image processing unit A. A printing control unit 11 and an image-reading control unit 12 are connected to the image-processing control unit 10. The printing control unit 11 controls the printing unit 7 and the image-reading control unit 12 controls the image reading unit 8.

The image-processing control unit 10 controls the printing control unit 11. According to control of the image-processing control unit 10, the printing control unit 11 outputs instructions to print data including image data to the printing unit 7. The printing unit 7 forms and outputs an image on a medium such as transfer paper. The printing unit 7 is capable of full-color printing. The printing unit 7 can be realized using any known printing methods such as thermal sublimation transferring, silver halide photography, direct thermal recording, and hot melt thermal transferring may be employed, besides electrophotography.

The image-reading control unit 12 drives the image reading unit 8 under the control of the image-processing control unit 10. The image reading unit 8 optically reads the image of the document. Precisely, a lamp irradiates a light on the document, and the light reflected from the document is received by a photoreceptor via a mirror or a lens. The photoreceptor is, for example, a charge coupled device (CCD). The image-reading control unit 12 performs analog to digital conversion of the read image, and creates digital image data of eight bits of each of red, green, and blue (RGB).

The image-processing control unit 10 is a microcomputer that includes a central processing unit (CPU) 13, a synchronous dynamic random access memory (SDRAM) 14 such as memory device, a read only memory (ROM) 15, and a non-volatile random access memory (NVRAM) 16 which are connected by a bus. The CPU 13 is the main processor. The SDRAM 14 stores the image data. The ROM 15 stores control programs etc. The NVRAM 16 holds data which has information such as system log, system setting, and log information recorded in it, even when the power supply is put OFF.

A hard disk drive (HDD) 17, a LAN controller 18, and a FAX control unit 20 are connected to the image-processing control unit 10. The HDD 17 stores job history and image data in a large quantity. The LAN controller 18 connects the image processing unit A to the LAN 2 via a HUB 19 inside the unit that is a line concentrator. The FAX control unit 20 performs the FAX control. The FAX control unit 20 is connected to an exchanger (PBX) 22 that leads to a public telephone network 21, thereby enabling the digital color copy machine 1 to communicate with a remote FAX.

Further, a display control unit 23 and an operation-input control unit 24 are connected to the image-processing control unit 10. The display control unit 23 outputs an image-display control signal to the information processing unit B via a communication cable 26 that is connected to a control panel I/F 25 by the control by the image-processing control unit 10, and performs the control of the image display of the operation panel P of the information processing unit B. The operation-input control unit 24 inputs an input control signal according to the function setting and the input operation by an operator from the operation panel P in the information processing unit B via the communication cable 26, which is connected to the control panel I/F 25, by the control by the image-processing control unit 10. In other words, the image processing unit A can directly monitor the operation panel P via the communication cable 26.

Therefore, in the image processing unit A, the communication cable 26 is connected to the image processing unit that is included in the conventional image processing apparatus, and the operation panel P in the information processing unit B is used. In other words, the display control unit 23 and the operation-input control unit 24 in the image processing unit A operate as units connected to the operation panel P.

The image processing unit A analyzes a command that carries printing instructions and printing data as image information from the external devices (the server computer 3, the client computer 4, and the facsimile etc.), performs bitmap conversion of the printing data so that the printing data can be printed as output image data, then analyses the printing mode from the command, and determines the operation. The printing data and the command are received either via the LAN controller 18 or via the FAX control unit 20.

The image processing unit A can transfer document reading data and printing data stored in the SDRAM 14 and the HDD 17, can output image data that is processed for outputting the document reading data and the printing data, and compressed data obtained by compressing the document reading data and the printing data, to external devices (i.e. to the server computer 3, the client computer 4, and to the facsimile etc.).

Further, the image processing unit A transfers the image data that is read by the image reading unit 8 to the image-processing control unit 10. The image processing unit A, then, applies correction to the signal deterioration caused due to quantization of an optical system and a digital signal, and writes this image data in the SDRAM 14. Thus, the image data stored in the SDRAM 14 is converted into output image data in the printing control unit 11, and is output to the printing unit 7.

The information processing unit B is now explained in detail. The information processing unit B has a structure of a microcomputer that is controlled by a general-purpose operating system (OS) which is used in an information processing unit called as a personal computer in general. The information processing unit B includes a CPU 31 which is a main processor. The CPU 31 includes a memory unit 32 and a storage-device control unit 35 that are connected by the bus connection. The memory unit 32 includes a read only memory (ROM) that is a memory exclusively for reading and has a start-up computer program and random access memory (RAM) that is a working area of the CPU 31, stored in it. The storage-device control unit 35 controls input and output of data to and from a storage device 34 such as an HDD which stores the OS and an application program.

A LAN controller 33 that connects the information processing unit B to the LAN 2 via the HUB 19 is connected to the CPU 31. An Internet protocol (IP) address that is a network IP address assigned to the LAN controller 33 is different from the IP address that is assigned to the LAN controller 18 of the imaged processing unit A. Thus, the digital color copy machine 1 is assigned with two IP addresses. In other words, the image processing unit A and the information processing unit B are connected to the LAN 2 and the data exchange between the image processing unit A and the information processing unit B is possible.

Since the digital color copy machine 1 is connected to the LAN 2 via the HUB 19, apparently it looks as if only one IP address is assigned. Therefore, wiring connections etc. can be made easily without disturbing the neat appearance.

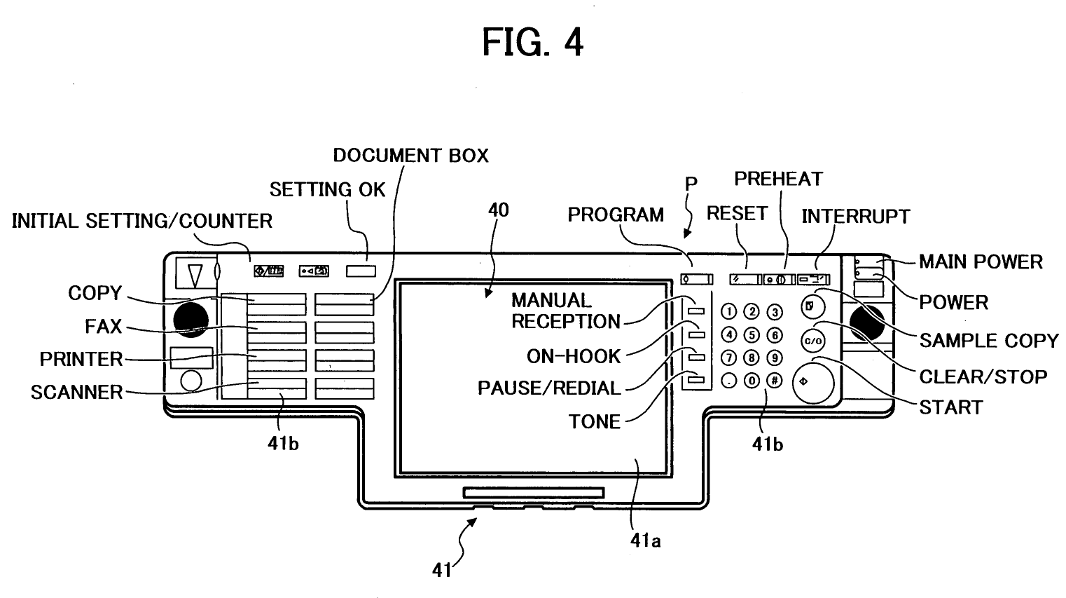

Moreover, an operation-input control unit 37 and a display control unit 36 that controls the operation panel P are connected to the CPU 31. FIG. 4 is a top view of the operation panel P. The operation panel P includes a display unit 40, which is, for example, a liquid crystal display (LCD), and an operation-input device 41. The operation-input device 41 includes a touch panel 41a and a keyboard 41b. The touch panel 41a is of a type such as ultrasonic and acoustic waves laminated on the display unit 40 and the keyboard 41b includes a plurality of keys. The keyboard 41b includes keys such as a start key to indicate start of image reading, a numeric key pad to input values, a reading-condition setting key to set destination to which the image data read is transmitted, and a clear key. Thus, the display control unit 36 outputs the image-display control signal to the display unit 40 via a control panel I/F 38, and displays, on the display, predetermined items in accordance with the image-display control signal unit 40. On the other hand, the operation-input control unit 37 receives an input control signal according to the function setting and the input operation by the operator at the operation-input unit 41 via the control panel I/F 38.

A control panel communication unit 39 that is connected to the control panel I/F 25 in the image processing unit A via the communication cable 26 is connected to the CPU 31. The control panel communication unit 39 receives the image-display control signal that is output from the image processing unit A, and transmits an input control signal according to the function setting and the input operation by the operator at the operation panel P to the image processing unit A. More concretely, the image-display control signal from the image processing unit A that is received at the control panel communication unit 39 is subjected to data conversion to be displayed on the display unit 40 in the operation panel P, and then, is output to the display control unit 36. The input control signal according to the function setting and the input operation by the operator at the operation panel P is subjected to data conversion to correspond to a format according to the specifications in the image processing unit A, and then, is input to the control panel communication unit 39.

Thus, the application program and the OS to be executed by the CPU 31 are stored in the storage device 34. In this context, the storage device 34 functions as a storage medium that stores the application program. In this digital color copy machine 1, when the user turns power on, the CPU 31 starts a start-up program stored in the memory unit 32, and reads the OS stored in the storage device 34 into the RAM inside the memory unit 32 to start the OS. The OS enables the computer program to be executed according to the user's operation, reads and saves information. Windows (registered trademark) is an example of a typical OS. Operation program running on such the OS is called as an application program. The OS for the information processing unit B is a same OS as the OS for the information processing unit (such as the server computer 3 and the client computer 4), i.e. a general-purpose OS such as Windows (registered trademark).

The digital color copy machine 1 includes the external media input-output unit 9 that can handle a flexible disk drive, an optical disk drive, a magneto-optical disk drive, and a semiconductor media drive. These types of drives read code included in a computer program and an image file etc. which are stored in the storage medium M such as a flexible disk (FD), a hard disk, an optical disk (such as a compact disk-read only memory (CD-ROM), compact disk-recordable (CD-R), digital versatile disk-read only memory (DVD-ROM), digital versatile disk-read only memory (DVD-ROM), digital versatile disk-random access memory (DVD-RAM), digital versatile disk-recordable (DVD-R), DVD+R, digital versatile disk-rewritable (DVD-RW), and DVD+RW), a magneto-optical disk (MO), and a semiconductor medium. Program codes (control computer program) such as various application programs of OS and drives, and image files are stored in the storage medium M. Such the external media input-output unit 9 functions as a reading unit that reads data stored in a medium. The external media input-output unit 9 is controlled by an input-output device control unit 42 that is connected to the CPU 31 by the bus connection.

The application program to be stored in the storage device 34 may be an application program obtained by installing an application program stored in the storage medium M. Therefore, the storage medium M can also function as the storage medium that stores the application program. Moreover, the application program may be obtained from an external source via the Internet 6 and the LAN 2 to be installed in the storage device 34.

Various interfaces 43, such as a universal serial bus (USB), IEEE 1394, and a small computer system interface (SCSI), are connected to the input-output device control unit 42. Various external equipments (such as a digital camera) can be connected via these interfaces 43.

The information processing unit B is connected to the server computer 3, which functions as a mail server and DNS etc., via the LAN 2, as well as to the Internet 6 via the communication control unit 5. Mail software, which is an application program, is installed in the storage device 34, and transmission and reception of E-mail is possible in the information processing unit B provided that a mail account (mail address) is assigned to the information processing unit B.

The following is a description of a function peculiar to the digital color copy machine 1. Since the function of the image processing unit A of the digital color copy machine 1 is not much different from the function of the conventional digital color copy machine, the description of the function is omitted here. Among arithmetic processing that is executed by the CPU 31 in the information processing unit B according to the application program, which runs on the OS, the processing peculiar to the embodiment is described below.

The following is a description of a form creating process executed by the CPU 31 of the information processing unit B of the digital color copy machine 1.

A form holds layout information (area specifying information) for fitting an image and characters to make one image. Information such as, name, location, and size of each area, order of display (for determining a priority order of display of duplicate portion when areas are duplicate), and size of overall form is defined as layout information (area specifying information). More concretely, in a form, area for accommodating an image to be fitted, character field for inserting as characters a FAX number and a file name while transmitting and printing, and a background which is fixed characters and image etc., are provided. By defining the area and the character field etc. for each form, it is possible to have various usages. Such forms, as a rule, are provided at the time of shipment from a factory.

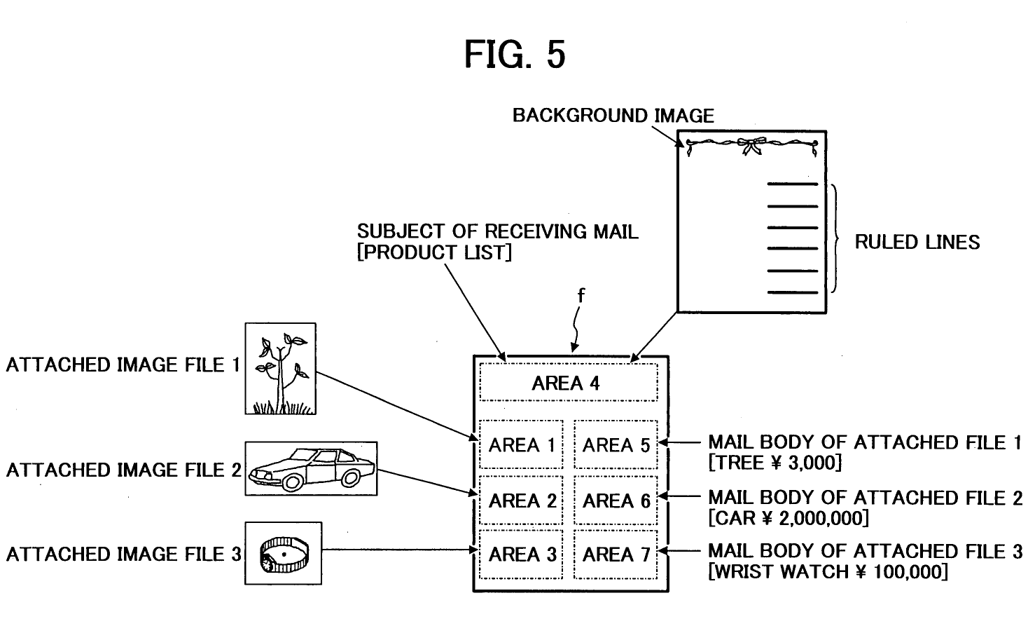

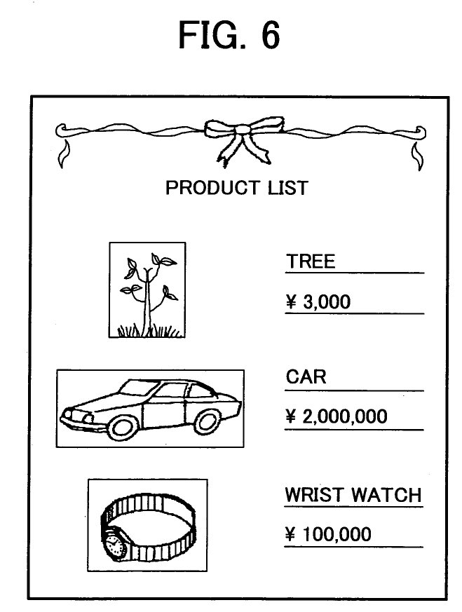

FIG. 5 is an example of a form that includes predetermined information and FIG. 6 is an example of an image in which images and characters are combined according to the form. The example of the form shown in FIG. 5 is an example of combining a form related to an E-mail that is transmitted to the digital color copy machine 1. From among E-mails which are transmitted to the digital color copy machine 1, as to for which E-mail the forms are to be combined is determined by information such as sender's mail address in the E-mail, receiver's mail address at the digital color copy machine 1, subject, and contents of a mail body. The E-mail that is subjected to combining of forms is specified by registering in advance as to by which information the process is to be performed. As to which information is to be inserted into each area is also registered in advance. For example, a form example f shown in FIG. 5, for an E-mail that is sent from a certain specific mail address, it is registered in advance that an image file which is attached to that E-mail is to be pasted in areas 1 to 3, a subject of that E-mail is to be pasted in area 4, and a mail body corresponding to each attached image file is to be pasted in areas 5 to 7. Regarding fixed background images and ruled lines, as to which background images and ruled lines are to be inserted is also registered in advance. Data in which the forms are combined in such a manner is divided into each layer and the data management is performed.

Images shown in FIG. 6 in which the forms are combined in such a manner are processed (converted to files such as PNG (Portable Network Graphics, PDF (Portable Document Format), JPEG (Joint Photographic Expert Group), and TIFF (Tagged Image File Format) according to a destination (SEND MAIL, SEND SHARED FOLDER, SEND FAX, STORE, PRINT), and output.

If SEND MAIL is selected as a destination, an E-mail attached with an image in which the forms are combined (JPEG and TIFF file), is created and is sent via the communication control unit 5 and the Internet 6 to an E-mail address provided in advance.

If SEND SHARED FOLDER is selected as a destination, the image in which the forms are combined is output via the LAN 2 to a shared folder of the server computer 3 and the client computer 4, which is provided in advance.

If SEND FAX is selected as a destination, the image in which the forms are combined is converted to facsimile image information (TIFF file) and is output together with a FAX number that is provided in advance to the image processing unit A. When the image processing unit A receives the facsimile image information together with the FAX number, the image processing unit A transmits facsimile image information in which the image in which the forms are combined to a remote facsimile via the FAX control unit 20.

If STORE is selected as a destination, the image in which the forms are combined is stored in the storage device 34 of the information processing unit B.

If PRINT is selected as a destination, a print instruction that includes an image in which the forms are combined is output to the image processing unit A. As the image processing unit A receives the print instruction that includes the image in which the forms are combined, the image in which the forms are combined is formed on a medium like a paper in the printing unit 7 and then output.

An example in which the forms are combined in the image that is attached to an E-mail is described here. However, it is not restricted only to this example. The image in which the forms are combined may also be an image file stored in the storage medium M which is read in the external media input-output unit 9 or an image file that is acquired from an equipment (such as a digital camera) that is connected to various interfaces 43 such as USB (Universal Serial Bus), IEEE (Institute of Electrical and Electronic Engineers) 1394, and SCSI (Small Computer System Interface) or an image file that is acquired via the LAN 2 from the server computer 3 and the client computer 4, or facsimile image information that is acquired via the FAX control unit 20, or an image that is read by the image reading unit 8.

Conventionally, the forms have been selected from those which are provided at the time of shipment from the factory. However, nowadays, due to rapid progress of digital information equipment such as digital camera, there has been a tendency to have various electronic documents. This, sometimes, necessitates customization and creating of new forms which have been available by default.

In order to cope with this situation, in the first embodiment, executing the form creating process enables to create new forms and to add fields to the existing forms.

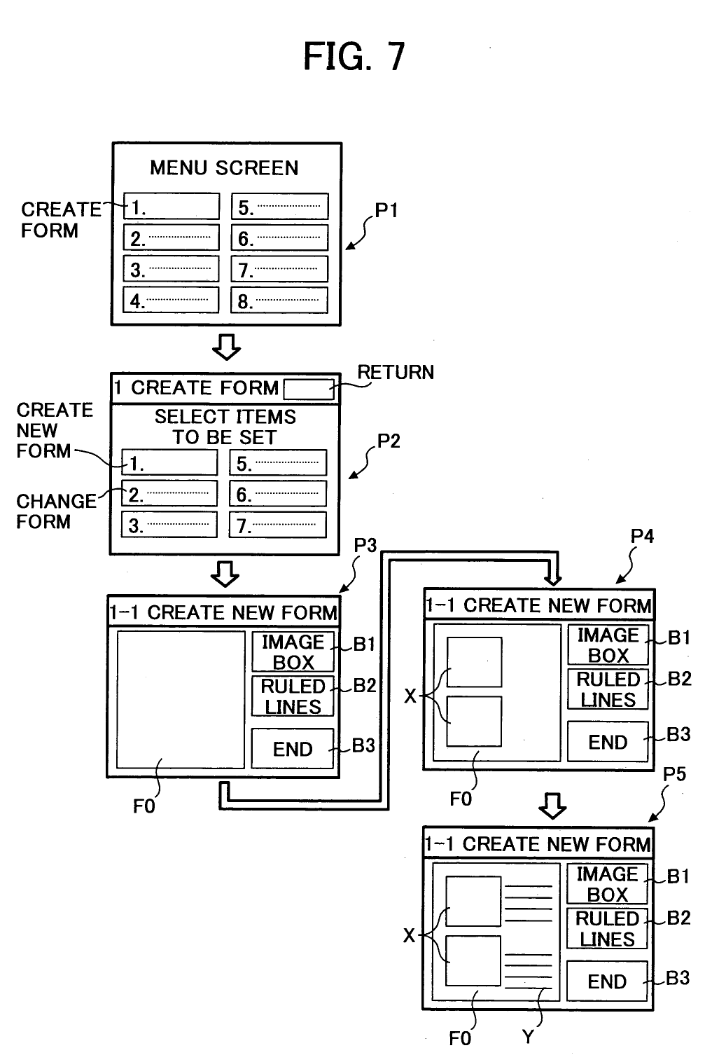

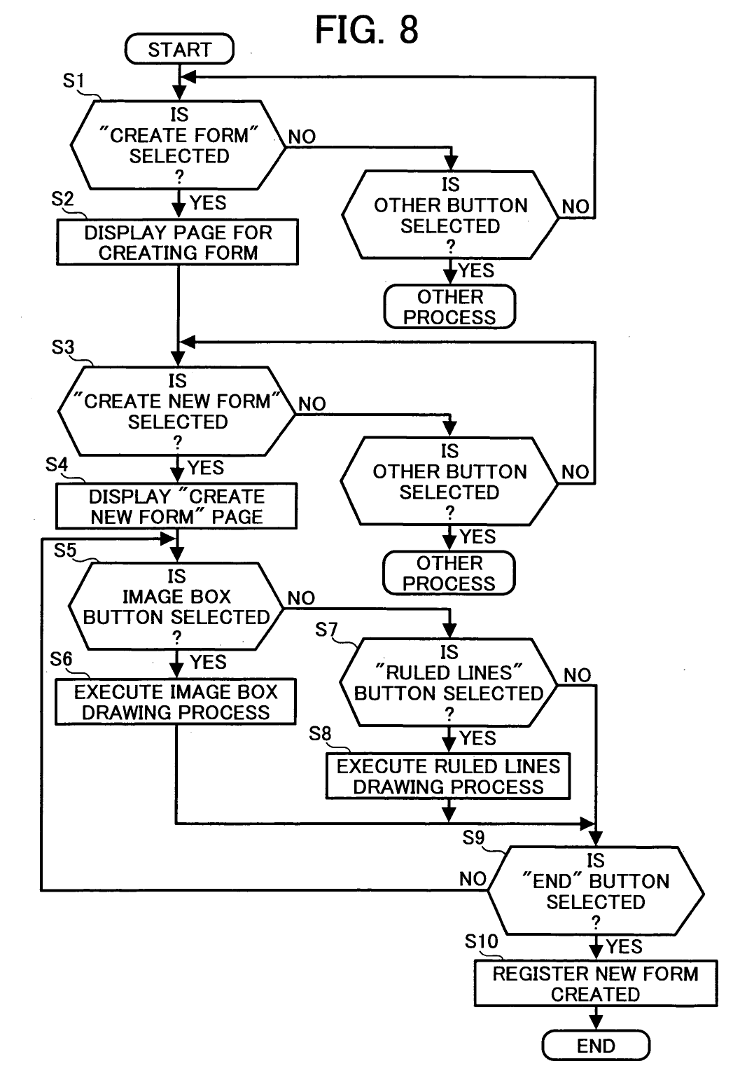

FIG. 7 is an illustration of a transition of an image that is displayed on the display unit 40 of the operation panel P when a form creating process is performed. FIG. 8 is a flow chart illustrating mainly a process of creating a new form in the form creating process. As shown in FIG. 7, the CPU 31 of the information processing unit B displays a screen P1 on the display unit 40 of the operation panel P. The screen P1 is a menu screen.

While the screen P1 is displayed on the display unit 40, if CREATE FORM button on the screen P1 is selected via the touch panel 41a (Y at step S1), a screen P2 is displayed on the display unit 40 of the operation panel P (step S2).

The screen P2 is a screen for creating a form. A list of processing items is displayed on the screen P2. If CREATE NEW FORM button on the screen P2 is selected via the touch panel 41a (Y at step S3), a screen P3 is displayed on the display unit 40 of the operation panel P (step S4).

The screen P3 is for creating a new form. An IMAGE BOX button B1, a RULED LINES button B2, an END button B3, and a base F0 that is a base of the new form are displayed on the screen P3.

If the IMAGE BOX button B1 is selected via the touch panel 41a (Y at step S5), the CPU 31 of the information processing unit B executes an image box drawing process (step S6: a new-form creating unit). A screen P4 indicates drawing of image boxes X in the image box drawing process. As shown in the screen P4, the image box drawing process disposes the image boxes X on the base F0, and determines inserting position of an image. For drawing the image boxes X, a range specification method by diagonal definition which is used in a word processor software is used.

On the other hand, if the RULED LINES button B2 on the screen P3 is selected via the touch panel 41a (Y at step S7), the CPU 31 of the information processing unit B executes ruled lines drawing process. (step S8: new-form creating unit). A screen P5 indicates drawing of ruled lines Y in the ruled lines drawing process. As shown in the screen P5, the ruled lines drawing process sketches the ruled lines Y by drawing lines on the base F0.

The processes from step S5 to step S8 are repeated until the END button B3 is selected via the touch panel 41a (Y at step S9).

If the END button B3 is selected via the touch panel 41a (Y at step S9), a new form created by performing processes at the steps S5 to S8 is registered (step S10: new-form registering unit) and the new-form creating process is ended.

A case in which a CHANGE FORM button on the screen P2 is selected via the touch panel 41a is described below.

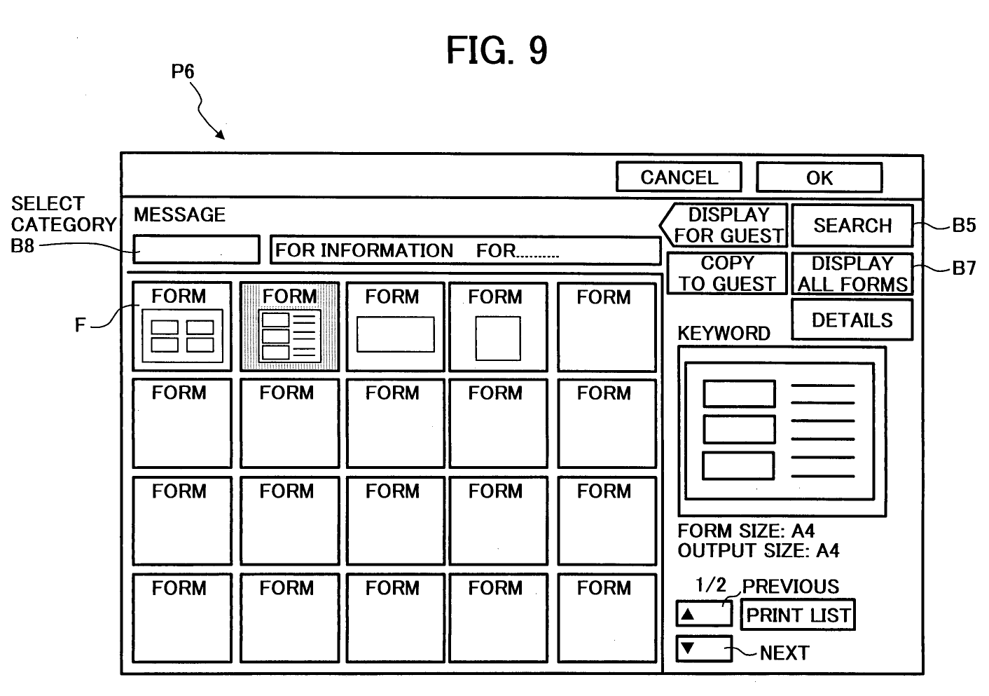

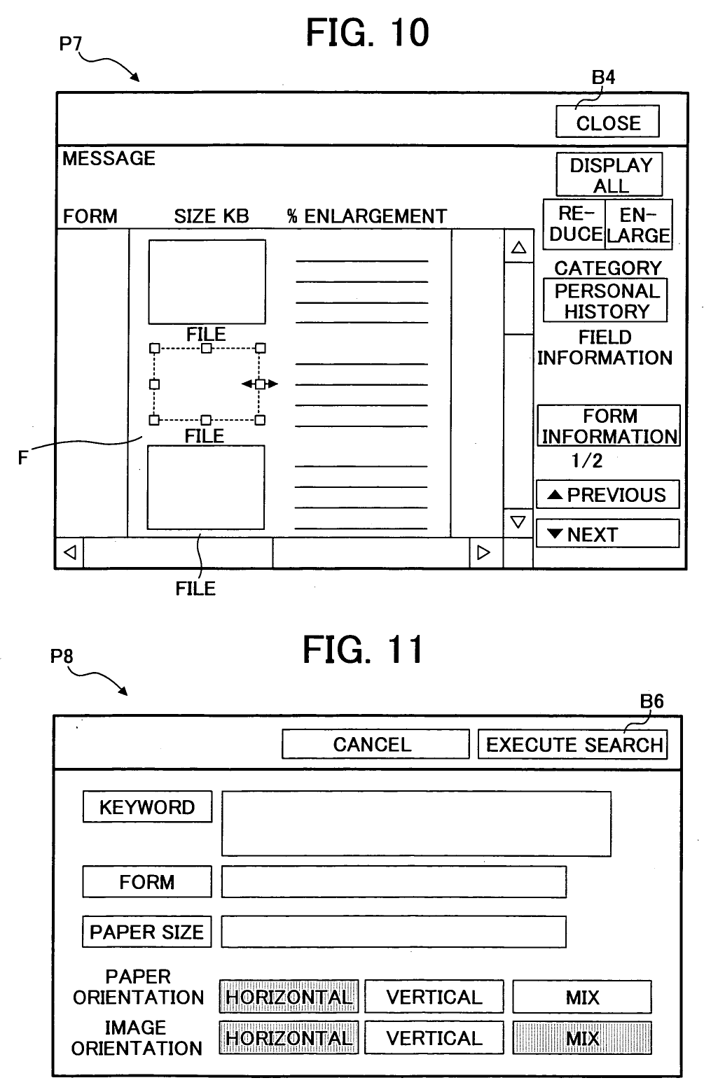

If a CHANGE FORM button on the screen P2 is selected via the touch panel 41a, the CPU 31 of the information processing unit B displays a screen P6 shown in FIG. 9 on the display unit 40 of the operation panel P. The screen P6 is a screen for selecting a form. A list of registered forms F is displayed on the screen P6. In this case, among forms F which are displayed on the screen P6, if a form that is to be changed is selected via the touch panel 41, the CPU 31 of the information processing unit B displays a screen P7 as shown in FIG. 10 on the display unit 40 of the operation panel P. The screen P7 is a form details display screen that displays a form in detail. On the form details display screen, a form F can be changed by shifting a location and changing area that is set. An operation for changing the area on the form F is similar to a new-form creating process. In this case, a function of form changing unit is executed.

Further, if a CLOSE button B4 on the screen P7 is selected via the touch panel 41a, the CPU 31 of the information processing unit B checks content that is changed, registers a form that is changed, and ends the form changing process. In this case, a function of changed-form registering unit is executed.

In the present embodiment, a large number (not less than 100) of forms are registered at the time of shipment from the factory. Therefore, all the forms F which are registered in the display unit 40 of the operation panel cannot be displayed at the same time and, normally, the forms F are displayed page wise on the screen P6 (screen for selecting a form). For this reason, according to the present embodiment, the forms F can be displayed upon search by name and keyword. Concretely, if a SEARCH button B5 on the screen P6 is selected via the touch panel 41a, the CPU 31 of the information processing unit B displays a screen P8 as shown in FIG. 11 on the display unit 40 of the operation panel P. The screen P8 is a screen for searching a form. Key word (for example meta-information added to input information), form, paper size, paper orientation, image orientation of an input image, are set on the screen P8 (screen for searching a form) and a START SEARCH button B6 is operated via the touch panel 41 to start search (form searching unit). The form searched is displayed on the screen P6 (screen for selecting a form) by operating DISPLAY ALL FORMS button B7 on the screen P6 via the touch panel 41a.

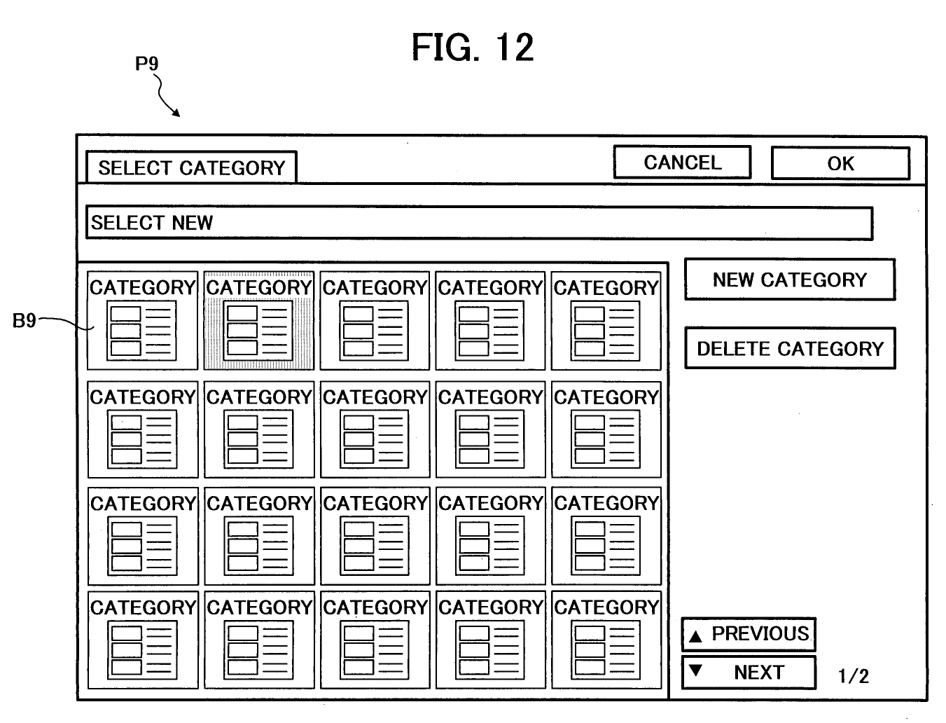

According to the first embodiment, the forms F have a hierarchy structure according to a category. Concretely, if a SELECT CATEGORY button B8 on the screen P6 is operated via the touch panel 41a, the CPU 31 of the information processing unit B displays a screen P9 as shown in FIG. 12 on the display unit 40 of the operation panel P. The screen P9 is a screen for selecting a category. In the screen P9, a button B9 for category wise virtual folders is displayed as thumbnails. By selecting the button B9 that displays thumbnails according to the category, the form F according to the category can be displayed and selected.

In this case, by registering new layout information that is created as forms, the new forms can be registered. This enables to provide forms of various layouts corresponding to various images sent and printed matters, thereby making it more convenient to use.

Moreover by changing the layout information of the existing forms and registering it, the forms can be changed easily. This enables to provide forms of various layouts corresponding to various images sent and printed matters, just by changing the forms.

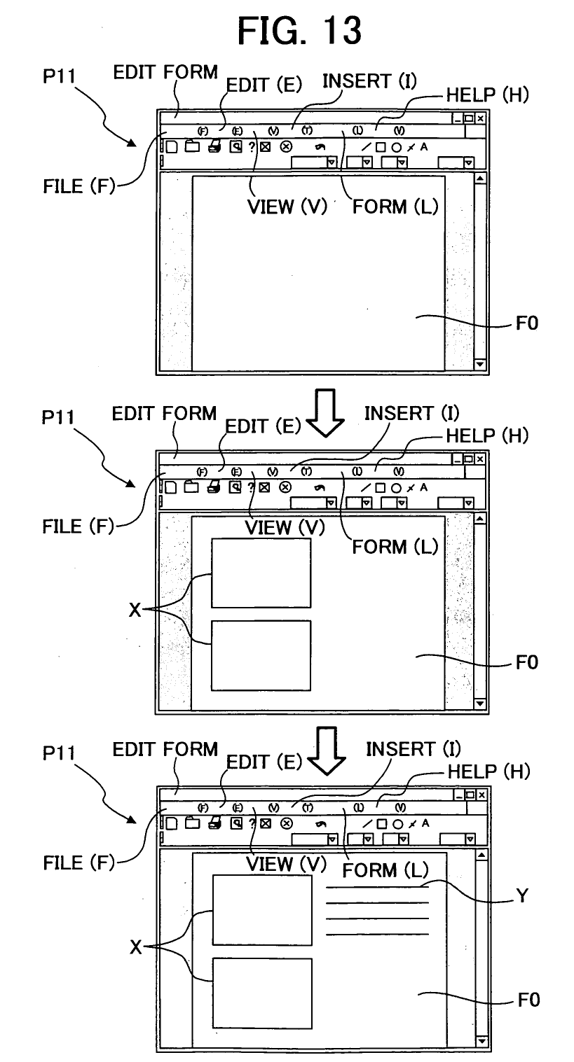

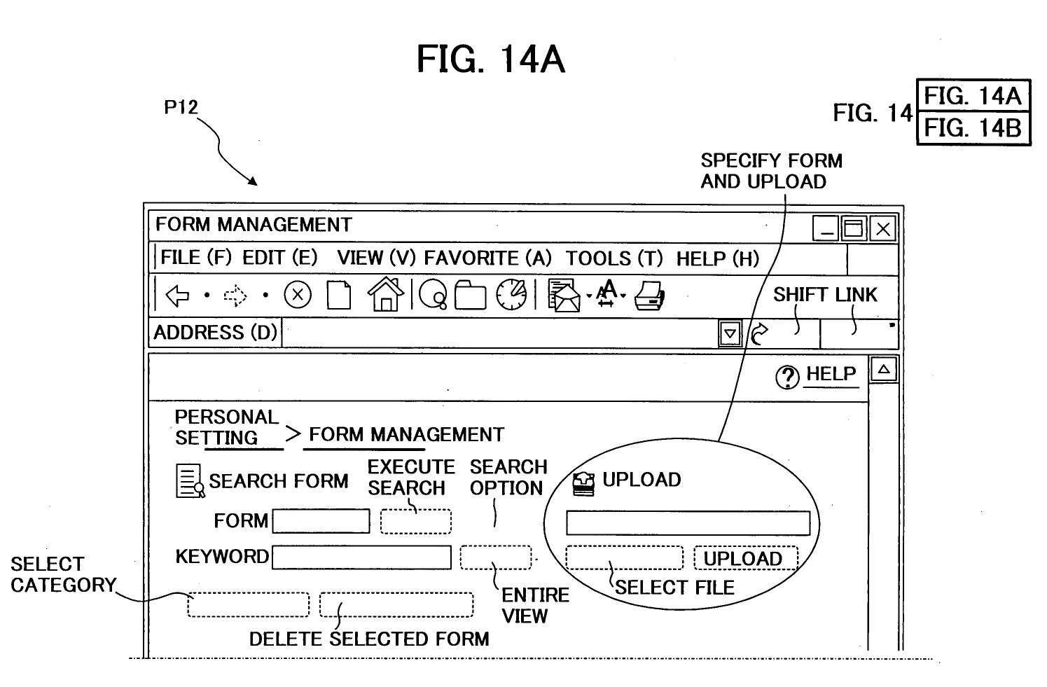

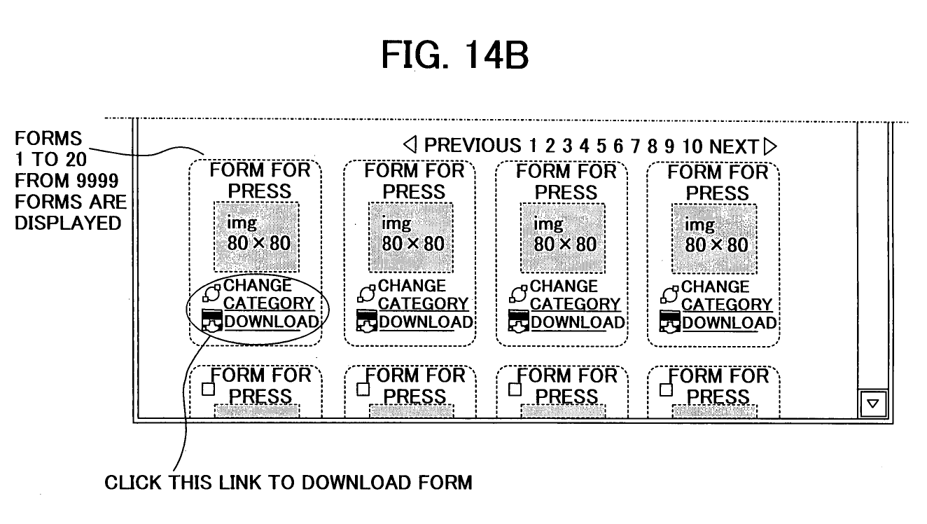

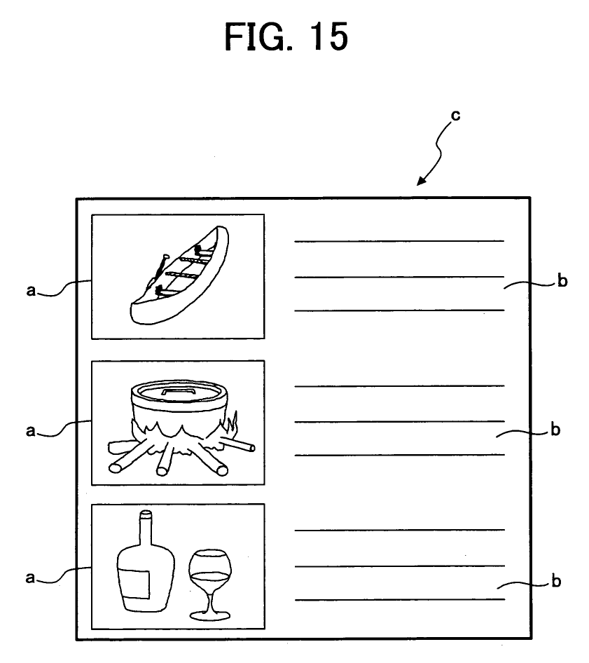

A second embodiment of the present invention is described below with reference to FIGS. 13 and 14. The same reference numerals are used in a part of the second embodiment that is identical to the part described in the first embodiment and the description of the identical part is omitted. According to the first embodiment, the form creating process is executed by the information processing unit B of the digital color copy machine 1. However, according to the second embodiment, the form creating process is executed by the client computer 4 that is connected via the LAN 2, which is different than that according to the first embodiment.

A user downloads and installs a form creating computer program (an application program that is run in an OS of the client computer 4) in the client computer 4. For creating a form, the form creating computer program installed in the client computer 4 is run to execute the form creating process.

FIG. 13 is an illustration of a transition of a display screen when a form creating process is executed in the client computer 4. The client computer 4 is not different than a normal personal computer, hence the description is omitted. As shown in FIG. 13, the client computer 4 displays a screen P11 on a display unit (not shown).

The screen P11 is a screen for creating new-form. A base F0 which is a base of a new form is displayed on the screen P11. With the base F0 displayed on the screen P11, the user creates a new form by drawing image boxes X on the base F0 and drawing ruled lines Y by drawing lines on the base F0. For drawing the image boxes X, the range specification method by diagonal definition which is used in the word processor software, is used. A function of the new-form creating unit is executed in this case.

The new form thus created is accessed from the client computer 4 to the digital color copy machine 1 via a Web browser. By making the access, the new form is uploaded from the client computer 4 to the digital color copy machine 1 by specifying on a form management screen P12 that is displayed and the new form is registered. In this case, a function of a new-form transmitting unit is executed.

As shown in FIG. 14, a list of existing forms is displayed on the form management screen P12. The desired form can be downloaded to the client computer by specifying the form from the list. The downloaded form can be changed by a technique similar to that of creating a form. In this case, a function of a form changing unit and a function of a changed-form transmitting unit are executed.

New layout information is created in the client computer 4 that is connected to the digital color copy machine 1 via the LAN 2 and is transmitted as a form to the digital color copy machine 1. The form transmitted to the digital color copy machine 1 is registered newly. This enables to provide various layout forms corresponding to various images sent and printed matters.

Moreover, the existing forms transmitted from the digital color copy machine 1 are received. Layout information of the existing forms that are received, is changed and transmitted as a form to the digital color copy machine 1. The form received by the digital color copy machine 1 is registered. This enables to change easily various layout forms corresponding to various images sent and printed matters, in the client computer 4.

According to the second embodiment, an application example of a digital color copy machine known as the so called MFP as an image processing apparatus is described. However, the second embodiment is not restricted only to the digital color copy machine. It may also be applicable to an image processing apparatus that includes at least one of an image forming unit (printing unit 7) that is connected to the server computer 3 and the client computer 4 via the LAN 2 and forms an image on a medium based on image data and an image reading unit (image reading unit 8) that reads a document image. The second embodiment can also be applied to a digital monochrome copy machine, a monochrome copy machine, a color copy machine, a scanner, a monochrome printer, and a color printer etc.

According to the present invention, it is possible to provide forms of various layouts corresponding to various images sent and printed matters, thereby making it more convenient to use.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An image processing apparatus that creates a layout image by fetching a layout with various data according to layout information that is held by a desired form which is selected from either one type or a plurality of types of forms which are registered, comprising:
a new-form creating unit that creates new layout information and creates a new form from the new layout information; and
a new-form registering unit that registers the new form.

2. The image processing apparatus according to claim 1, further comprising:
a form changing unit that changes layout information of a pre-registered form; and
a changed-form registering unit that registers the pre-registered form whose layout information is changed by the form changing unit.

3. The image processing apparatus according to claim 1, comprising:
a search-condition receiving unit that receives a search condition; and
a form searching unit that searches a form from among pre-registered forms based on the search condition.

4. The image processing apparatus according to claim 1, further comprising a form managing unit that classifies pre-registered forms based on a category, and hierarchically manages the pre-registered forms.

5. A computer program that contains instructions which when executed on a computer cause the computer to create a layout image by fetching a layout with various data according to layout information that is held by a desired form which is selected from either one type or a plurality of types of forms which are registered, the computer program causes the computer to execute:
creating new layout information and creating a new form from the new layout information; and
registering the new form.

6. The computer program according to claim 5, further causing the computer to execute:
changing layout information of a pre-registered form; and
registering the pre-registered form whose layout information is changed at the changing.

7. The computer program according to claim 5, further causing the computer to execute:
receiving a search condition; and
searching a form from among pre-registered forms based on the search condition.

8. A computer-readable storage medium that stores a computer program that contains instructions which when executed on a computer cause the computer to create a layout image by fetching a layout with various data according to layout information that is held by a desired form which is selected from either one type or a plurality of types of forms which are registered, the computer program causes the computer to execute:
creating new layout information and creating a new form from the new layout information; and
registering the new form.

9. An information processing apparatus that is connected via a network to an image processing apparatus that creates a layout image by fetching a layout with various data according to layout information that is held by a desired form which is selected from either one type or a plurality of types of forms which are registered, comprising:
a new-form creating unit that creates new layout information and creates a new form from the new layout information; and
a new-form registering unit that registers the new form.

10. The information processing apparatus according to claim 9, comprising:
a form receiving unit that receives a pre-registered form from the image processing apparatus;
a form changing unit that changes layout information of the pre-registered form received; and
a changed-form transmitting unit that sends the pre-registered form whose layout information is changed by the form changing unit to the image processing apparatus.

11. A computer program that contains instructions which when executed on a computer cause an image processing apparatus to create a layout image by fetching a layout with various data according to layout information that is held by a desired form which is selected from either one type or a plurality of types of forms which are registered, the computer program causes the computer to execute:
creating new layout information and creating a new form from the new layout information that can be used in the image processing apparatus; and
sending the new form to the image processing apparatus.

12. The computer program according to claim 11, comprising:
receiving a pre-registered form from the image processing apparatus;
changing layout information of the pre-registered form received; and
sending the pre-registered form whose layout information is changed at the changing to the image processing apparatus.

13. A computer-readable storage medium that stores a computer program that contains instructions which when executed on a computer cause an image processing apparatus to create a layout image by fetching a layout with various data according to layout information that is held by a desired form which is selected from either one type or a plurality of types of forms which are registered, the computer program causes the computer to execute:
creating new layout information and creating a new form from the new layout information that can be used in the image processing apparatus; and
sending the new form to the image processing apparatus.
